(19) United States
(12) Patent Application Publication
(10) Pub. No.: US 2005/0243987 A1
(43) Pub. Date: Nov. 3, 2005

(54) Process and server for routing telephone calls

(76) Inventors: Stephane Polouchkine, Ranville (FR); Emmanuel Bertin, Escoville (FR)

Correspondence Address: BACHMAN & LAPOINTE, P.C., 900 CHAPEL STREET, SUITE 1201, NEW HAVEN, CT, 06510, US

(21) Appl. No.: 11/096,307

(22) Filed: Mar. 31, 2005

(30) Foreign Application Priority Data
Mar. 31, 2004 (FR) 04 03385

(51) Int. Cl. H04M 5/00; H04M 3/00; H04M 3/42; H04M 7/00

(52) U.S. Cl. 379/201.01; 379/221.01

(57) ABSTRACT

Process for managing calls to users of telecommunication networks, comprising the steps during which: the users each enter at least one call routing rule associating at least one condition applied to an incoming call characteristic with a routing action for the incoming call; a call routing server receives and determines the characteristics of an incoming call and the rules to be applied to it, and applies the determined rules to identify the actions to be performed; if several alternative actions are obtained by implementing the rules determined for the incoming call, the call routing server transmits notification of an incoming call to the called user indicating the alternative actions; the called user transmits indication of the alternative action chosen by the called user to the server; and the server processes the call by executing the alternative action chosen by the called user.

The present invention concerns a process and a server for routing telephone calls.

In particular, but not exclusively, it applies to fixed and mobile telecommunication networks and to public or private data transmission networks comprising a call routing server.

At the present time, users of telecommunication networks whether in a private or professional environment, each have numerous items of equipment or means of communication enabling them to communicate with other users. Yet user needs in terms of communication essentially depend upon user location and occupation at the time of use.

In this context, it is desirable to route calls to users wherever they may be and whatever they may be doing, in a manner that is adapted to their situation whatever be the situation. This routing must be made in fully transparent fashion for the user, i.e. without any action being needed on the user's part to give notice of a change in situation. For the caller, this routing must also be transparent i.e. the calling party must not have to concern him or herself with choosing a terminal with which to establish a communication with the called user.

Current communication systems offer several services that are activated on the arrival of a telephone call, such as forwarding the call to a voice mailbox or another extension. These systems choose the service or services to be activated in accordance with criteria that are generally binary. The result is that the user receiving a call does not have any means with which to choose the manner in which the call is to be processed to take into account the current location or activity of the user. For example, if the user receiving a call does not wish to be disturbed, it may be desirable to direct calls from unknown callers to a voice messaging service. On the other hand if the caller is known to the user, the latter may wish to take the call on a land telephone or a mobile telephone via call forwarding should it be desired not to disturb other persons.

The Applicant developed a system described in patent application FR 02 02976 enabling a caller to choose how the call is to be processed having regard in particular to the constraints specified by the called user, optionally defined in relation to the identity of the caller, and the free or engaged status of the called party's telephone line.

However, with this system it is not possible for called parties to choose how each received incoming call is to be processed at the time it is received.

The purpose of the present invention is to overcome this drawback. This purpose is achieved by providing a process for managing calls intended for users of telecommunication networks, each of the users having at least one telecommunication means connectable to one of the telecommunication networks, the process comprising steps during which:
the users each enter at least one call routing rule associating at least one condition, applied to a characteristic of an incoming call, with a routing action for the incoming call, and
a call routing server receives an incoming telephone call intended for a user, determines the characteristics of the incoming call and the rules to be applied to the incoming call, applies the determined rules to identify the actions to be applied to the incoming call, and implements the identified actions on the incoming call.

According to the invention, at least some call routing rules specified by users comprise several alternative actions to be selected by the called user at the time the incoming call is received, the process also comprising the steps during which:
if several alternative actions are obtained by applying the rules determined for the incoming call, the call routing server transmits notification of an incoming call to a communication means accessible to the called user indicating the alternative actions from which the called user must choose,
the communication means of the called user transmits to the call routing server an indication of the alternative action chosen by the called user, and
the call routing server processes the incoming call by executing the alternative action chosen by the called user.

According to one embodiment of the invention, each of the conditions of the incoming call routing rules relates to at least one of the following data items:
the identity of the calling user,
the identity of the first caller in the event of call forwarding,
an “engaged” or “no reply” status of the communication means requested by the calling user,
the date and time of receipt of the call,
a priority level allocated to the incoming call,
presence status of the called party indicating whether the called user can be reached via at least one communication terminal,
network status,
the location of the called user, and
events external to the system.

According to another embodiment of the invention, the call routing actions are selected from among the following actions at the time of entering routing rules for incoming calls:
notify the called user of the arrival of an incoming call,
route the call to a specified actionable service belonging to the set of services to which the called user has subscribed and which can be used within the framework of the call routing service,
refuse the call, and
propose a list of alternative actionable services belonging to this set of services from which the called user must make a choice.

According to a further embodiment of the invention, this process also comprises a determination step to determine the accessibility status of each of the telecommunication means of each user.

According to a still further embodiment, this process also comprises a configuration step to configure the call routing service during which each user specifies a user profile grouping together:
the parameters required by the call routing server comprising access parameters to the communication means, via which the user can be reached, and to presence management servers with which the user is registered providing accessibility status to the communication means,
context definitions each relating to a situation in which the user has planned to be, each context being associated with respective call routing rules to be applied to incoming calls, and
personal information management data (PIM data) specifying time slots during which a context is activated.

The invention also concerns a call routing server intended for users of telecommunication networks, each of the users having at least one telecommunication means connectable to one of the telecommunication networks, the call routing server comprising means for receiving incoming telephone calls intended for users, means for determining the characteristics of incoming calls and call routing rules specified by users to be applied to incoming calls, means for implementing the rules to identify the actions to be applied to incoming calls, and means for executing the identified actions on incoming calls.

According to the invention, the call routing server also comprises:
means available to users to specify call routing rules, comprising one or more alternative actions to be selected by the called user at the time of receiving an incoming call,
means for transmitting notification of an incoming call to a communication means accessible to a called user, indicating the alternative actions from which the called user must choose, if several alternative actions are identified when implementing the determined rules for incoming calls,
means for receiving indications of alternative actions chosen by called users, and
means for routing incoming calls by implementing the alternative actions chosen by the called users.

According to one preferred embodiment of the invention, the call routing server is configured so that the means for executing identified actions on incoming calls and the means for routing incoming calls by implementing the alternative actions chosen by the users being called, are the same.

Advantageously, the call routing server has a modular architecture comprising a central unit and a set of functional modules, the central unit being designed to coordinate the processing carried out by the functional modules.

According to one embodiment of the invention, this call routing server comprises a configuration module enabling each of the users to specify a user profile grouping together:
some parameters required by the call routing server, including access parameters to the communication means via which the user can be reached and to presence management servers with which the user is registered providing an accessibility status to the communication means,
context definitions each corresponding to a situation in which the user has planned to be, each context being associated with respective call routing rules to be applied to incoming calls, and
personal information management (PIM data) specifying time slots during which a context is activated.

According to another embodiment of the invention, to transmit notification of an incoming call to a called user, the call routing server uses at least one of the following communication means:
electronic messaging,
instantaneous messaging,
SMS message,
overlaying of a window display on a computer screen,
overlaying of a window display on a television screen connected to a decoder linked to an IP network.

According to another embodiment of the invention, the call routing server is connected to at least one of the following telephony networks:
mobile telephone network
fixed telephone network
IP telephony network using SIP protocol.

A preferred embodiment of the invention is described below as a non-restrictive example with reference to the appended drawings in which:

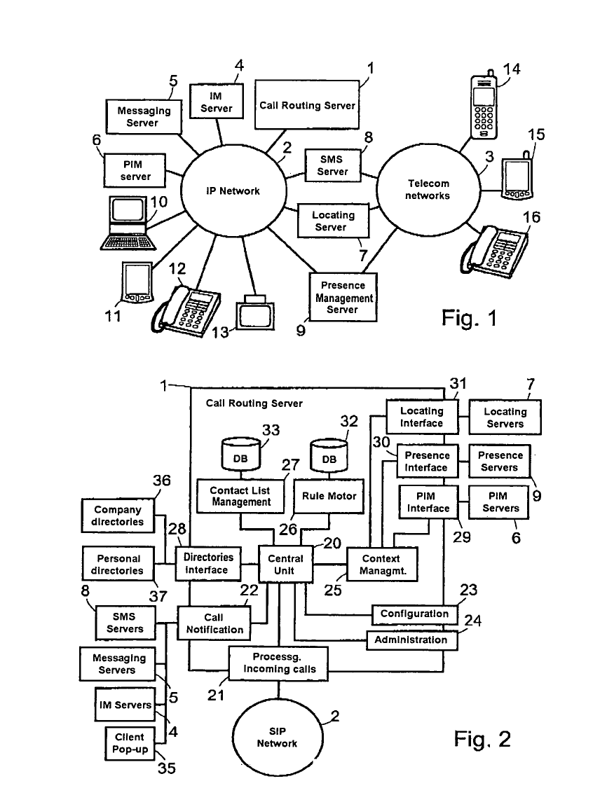

FIG. 1 schematically illustrates a telephone call routing server integrated in an environment of telecommunication networks to which user terminals are connected;

FIG. 2 shows the functional architecture of the telephone call routing server illustrated in FIG. 1.

FIG. 1 shows a data transmission system comprising a set of telecommunication and data transmission networks 2, 3 to which user terminals 10 to 16 are connected and servers 4 to 9 offering specialized communication services. Reference 2 denotes a set of public and/or private IP-type networks (Internet Protocol), e.g. the Internet network and Intranet networks. Reference 3 denotes a set of telephony networks of PSTN type (public switched telephone networks) or mobile type conforming for example to the GSM standard (Global System for Mobile Communication), GPRS (General Packet Radio Service) or UMTS (Universal Mobile Telecommunication system) standards.

The terminals connected to the IP networks 2 are of personal computer type 10 for example, or Personal Digital Assistant 11, telephone terminal 12 (IP telephony), or a television set 13 associated with a video decoder (Set Top Box). They may also be mobile terminals provided with GSM communication means and/or small range means such as those conforming to Bluetooth or Wi-Fi (Wireless Fidelity) standards (IEEE standards 802.11a or b), so that they can communicate with a local IP network of Intranet type. The terminals connected to telephony networks 3 are of land line type 16 via the SIP protocol (Session Initiation Protocol), mobile telephone type 14, or communicating personal assistant type 15 (for example equipped with a GSM telecommunication module).

The communication servers connected to the IP networks 2 comprise electronic messaging servers 5 for example or instantaneous messaging servers 4, personal information management (PIM) servers 6 storing information on each user's planned activities, presence management servers 9 with which to determine the accessibility or possibility of reaching users via one of networks 2, or locating servers 7 giving access to information with which to locate user terminals, namely the user's IP address for an IP network.

The communication servers connected to the mobile networks 3 comprise short message transmission servers 8, of SMS type for example (Short Message Service) or MMS type (Multimedia Messaging Service), these servers possibly being connected also to an IP network 2 to allow the transmission of short messages from an IP terminal, presence management servers 9 with which to determine the accessibility or possibility of reaching users via one of networks 3, and locating servers 7 giving access to information with which to locate the mobile terminals of users.

According to the invention, this system also comprises a call routing server 1, designed to enable called users to choose how received calls are to be transmitted (choice of protocol, network and terminal). The calls processed in the chosen manner may come from a fixed (PSTN or IP) or mobile telephone.

For this purpose, the server 1 may be designed to enable the user to define contexts corresponding to situations in which the user may find him/herself, such as “in the office and available”, “in the office at meeting”, “away on business”, “at another workplace”, “unreachable”, “at home and available”, “at home, busy”, etc.

At a given time, a context is active for each of the users of the call routing service, the activation of a context possibly being made manually by the user or automatically in relation to personal time schedules for which the activation periods of these contexts have been specified.

Server 1 is also designed to enable the user, for each context, to specify rules for triggering an action or service in relation to a condition.

A rule is characterized by two elements, namely a condition which constitutes the triggering element of the rule, and an action which is activated when the condition is met, for example “when engaged” (=condition) “forward the call to another terminal” (=action).

The conditions may relate to the following information:
the “engaged” or “no reply” status of the communication means requested by the calling user,
the identity of the caller or of the first caller when calls are forwarded,
the date and time of receipt of the call, for example in relation to electronic personal information management (PIM) of the called user,
priority of the call insofar as this information is available,
presence status of the called user indicating whether the called user can be reached via at least one communication terminal, and an availability status,
network status (bandwidth, infrastructure such as modem connection, LAN, . . . ),
location of the called user,
events external to the system, weather conditions for example, . . .

The available actions may be the following:
notify the called user that someone is trying to reach him/her, this notification comprising call data namely the date of receipt of the call and caller identity,
route the call towards a specified actionable service that is part of a group of services with which the called user is registered and which can be used for the call routing service (e.g. call forwarding to a voice mailbox or another telephone number),
refuse the call, and
propose a list of actionable services belonging to this set of services from which the called user must make a choice.

The action of notifying the called user may be associated with an indication of the terminal and/or service to be used to give such notification (electronic messaging, SMS, voice server, instantaneous message displayed on television screen via a decoder 13, window (pop-up) displayed on a computer screen 10, . . . ).

It is to be noted that the contexts defined by service users may specify a default terminal and/or service to be used for giving call notifications.

The user's terminal is connected to other terminals via an assembly of telecommunication and/or data transmission networks and at least one call routing server. It is configured to receive a call notification signal from the call routing server and comprises display means for this call notification. The call notification signal is associated with a list of choices of action to be selected by the user; the user's terminal comprising means for user selection from a choice of actions in the list, and means for transmitting the choice made back to the call routing server.

If notification is made in the form of a window (“pop-up”) displayed on the screen of a computer or television screen, the computer and the decoder associated with the television set are provided with related application software.

FIG. 2 shows an example of functional architecture for the call routing server 1 in an IP telephony network using SIP protocol (Session Initiation Protocol). In this figure, the server architecture is advantageously modular comprising the following modules:
a central unit 20 which coordinates all the processing carried out by the server to provide the call routing service,
a processing module 21 for incoming calls,
a notification module 22 for incoming calls,
a configuration module 23 integrating, for example, a Web interface accessible via an IP network 2 to enable each service user to configure the call processing service so that it is able to process received calls,
an administration module 24 integrating a Web interface for example via an IP network 2 to enable an administrator to manage accounts for each of the service users,
a context management module 25 to determine a current context of each service user,
a rule management module 26 to manage the rules specified by each of the users and execute the same on receiving an incoming call,
a contact list management module 27 to manage contact lists for each of the service users, and
a set of interface modules 28 to 31, to ensure interfacing between the call routing server and servers such as the personal information management (PIM) server 6, presence server 9, directory servers 36, 37 and locating servers 7.

Module 21 for processing incoming calls is in the form of an application server activated on receipt of an incoming call received via network 2. This module receives the call signal containing the respective identifiers of the calling and called users in particular, transmits the same for processing to the central unit 20 and executes call forwarding orders given by the latter.

The incoming call notification module 22 is designed to notify the called user of an incoming call. In accordance with the invention, this notification may be of two types, namely simple notification of an incoming call or notification with presentation of a list of processing choices to be applied to the incoming call from which the user must make a choice.

Notification may be in the form of an electronic message (e-mail or instantaneous message), or in the form of a window displayed on the screen of a computer 10 or television set 13 connected to a decoder linked to the IP network 2. If a processing list is presented, notification is made by a transmission means through which the called user can be reached immediately, such as instantaneous messaging or SMS, or the displaying of a window on a display screen (computer, television set), having regard to information on user presence on one or other of these transmission means and the rules specified by the called user.

Service configuration module 23 enables each user to specify a user profile grouping together:
all the parameters required by the service, in particular all the parameters needed to access the different communication means (terminals and services) which the user may possibly use, or to access the presence management servers 9 with which the user is registered,
context definitions each corresponding to a situation in which the user has planned to be, and identification of communication means which may be used to reach the user in relation to an urgency level, each context being associated with a set of rules to be applied to incoming calls.

Configuration module 23 is preferably accessible through an IP network 2 such as the Internet network, via a convivial, user-friendly configuration interface, e.g. Internet navigation software. When users access the service for the first time, they receive an identifier and password which can be used subsequently to modify user own profile or enter commands for the call routing server.

Context management module 25 is designed to determine a current called user context in relation to data provided by the personal information management (PIM), presence and locating interface modules 29 to 31.

The presence interface module 30 is registered as client to each presence management server so as to receive notification from the latter of any change in the presence status of service users. With the aid of these notifications, the interface module 30 updates the presence status of each service-user terminal depending on whether the user is reachable, on line or absent.

The rule management module 26 is designed to verify intrinsic and inter-rule coherency of the rules specified by each user via the configuration module 23, and stores these rules in a database 32. This module is called by the central unit 20 to determine the rule or rules applicable to an incoming call in relation to the current context of the called user, and to carry out the rules selected while ensuring their coherency, in particular to prevent loops, and send back to the central unit those actions to be performed.

The contact list management module 27 manages the contact lists for each service user, the data on each contact in these lists being derived from a company directory 36 or the user's personal directory 37, these directories being accessible via an IP network and the directory interface module 28. Each of a user's lists is drawn up by the user via the configuration module 23 and is characterized by an identifier which can be used when defining rules.

The directory interface module 28 is designed to consult company and personal directories whose addresses on the IP network are provided by the service users, to collect information (name, telephone number and optionally addresses, photo, etc.) on user contacts.

Examples of use of the service will now be described.

In a first example, a user A has configured the service using the configuration interface module 23 by defining a “family” context for which he entered the following rules:
if an incoming call arrives between 21h00 and 23h00 and the caller is on the “friends” contact list, the possible actions are “take the call” and “refuse the call”, otherwise the only possible action is “forward all calls to the voice mailbox”,
if an incoming call arrives between 23h00 and 7h00 the only possible action is “forward all calls to the voice mailbox”.

Also, in the “family” context, user A indicated that he wishes to be notified of all calls.

At 22h00 a user B calls user A, B being on the “friends” contact list of user A. This call is received by the incoming call processing module 21 which transmits signaling data on the incoming call to the central unit 20, namely the identifier of caller B (telephone number) and the identifier of called user A (telephone number). The central unit 20 calls the context management module 25 giving the identifier of the called user A to obtain the current context of user A. The context management module determines the current context of the called user, having recourse in particular to the personal information management interface 29 and the accessible terminals to which the called user has access after consulting presence interface 30.

In the example under consideration, the accessible terminals are the land line 12 or 16 of user A and the television set 13 which is connected to the IP network via a decoder.

The central unit 20 then calls rule management module 26 giving the identifier of the called user and his/her current context. Module 26 responds with the rules to be executed having regard to the called user's current context. The central unit then carries out the rules received on the basis of information on the incoming call. For this purpose, to determine whether caller B is on the “friends” contact list of user A, the central unit calls the contact list management module 27 giving the identifiers of the calling and called parties and the name of the contact list. Module 27 gives the name of the caller corresponding to the received identifier if this name is included in the indicated list.

By applying the rules received from rule management module 26, the central unit determines that for caller B, the called user A must be given the list of possible actions “take the call”, “refuse the call”. From the list of terminals accessible to the called user A, the central unit determines that this notification can be given via the television set. The central unit then signals the call notification module 22 giving the identifier of the caller, the list to be notified and the information with which to access the television decoder of called user A. Module 22 transmits the list of actions to the decoder's address which displays the information to be notified in an overlay window on the television screen. The called person A then sees on the screen “call from B, you can 1. take the call, 2. refuse the call”.

Called user A can then choose an option using a remote control of the television set 13 associated with a decoder, for example “take the call”, this choice being transmitted by the decoder to the notification module 22, then to the central unit. The central unit then sets up the communication between users A and B by forwarding the call to a terminal to which called user A has access.

If caller B is unknown to called user A, the central unit notifies the call to the latter, again using the accessible notification terminal and forwards the call to the voice mailbox of called user A.

In another example of use of the service, user A has configured the service using the configuration interface module 23 by defining an “office-meeting” context for which he entered the following rule:

“if the caller is my secretary”, the possible actions are “take the call” and “forward the call to my mobile telephone”, otherwise “forward all calls to my secretary”.

In this context, the user's computer 10 is accessible to the call routing server 1, and his/her mobile telephone.

If the caller is the secretary, the call routing server displays the following message on the computer screen of the called user:

“call from secretary, you can 1. refuse the call or 2. forward the call to the mobile telephone”.

The called user can then make a choice using the computer mouse for example. If the called user chooses the second option, the call routing server triggers forwarding of the call to the mobile telephone of the called user.

1-12. (canceled)

13. A process for managing calls to users of telecommunication networks, each of the users having at least one telecommunication means connectable to one of the telecommunication networks, the process comprising the steps of:
the users each entering at least one call routing rule associating at least one condition applied to an incoming call characteristic with a routine action for an incoming call, and
a call routing server receiving an incoming telephone call intended, for a user, determining characteristics of the incoming call and the rule(s) to be applied to the incoming call, applying the determined rule(s) to identify the actions to be applied to the incoming telephone call, and implementing the identified actions on the incoming telephone call, wherein at least some rules for incoming calls specified by the users comprise several alternative actions to be selected by the called user at the time of receiving the incoming telephone call;
if several alternative actions are obtained by applying the rules determined for the incoming call, the call routing server transmitting notification of an incoming call to a communication means accessible to the called user and indicating the alternative actions from which the called user must make a choice;
the communication means of the called, user transmitting to the call routing server an indication of the alternative action chosen by the called user; and
the call routing server processing the incoming telephone call by executing the alternative action chosen by the called user.

14. The process as in claim 13, further comprising relating each of the conditions of the routing rules for incoming calls to at least one of the following data items:
an identity of the calling user;
an identity of a first calling user if calls are forwarded;
an “engaged” or “no reply” status of the communication means requested by the calling user;
a date and time of receipt of the call;
a level of priority allocated to the incoming call;
a presence status of the called user indicating whether the called user is reachable via at least one communication terminal;
a status of the network;
a location of the called user; and
events external to the system.

15. The process as in claim 13, further comprising selecting the call routing actions from among the following actions when entering the rules for the routing of incoming calls:
notifying the called user of the arrival of an incoming call;
routing the call to an actionable specified service belonging to a set of services with which the called user is subscribed and which can be used for the call routing service;
refusing the call; and
proposing a list of alternative actionable services belonging to said set of services in which the called user must make a choice.

16. The process as in claim 13, further comprising determining an accessibility status for each of the telecommunication means of each of the users.

17. The process as in claim 13, further comprising performing a configuration step to configure the call routing service, during which each user specifies a user profile grouping together:
the parameters required by the call routing server including access parameters to the communication means through which the user can be reached and to present management servers with which the user is registered and which provide an accessibility status to the communication means;
context definitions each corresponding to a situation in which the user has planned to be, each context being associated with respective call routing rules to be applied to incoming calls; and
personal information management data (PIM) specifying time slots during which a context is activated.

18. A call routing server for calls to users of telecommunications networks, each of the users having at least one telecommunication means connectable to one of the telecommunication networks, the call routing server comprising:
means for receiving incoming telephone calls to users;
means for determining characteristics of incoming calls and rules for call routing specified by users to be applied to incoming calls;
means for applying the rules to identify the actions to be carried out on incoming calls;
means for carrying out the identified actions on incoming calls;
means available to users for specifying call routing rules comprising one or more alternative actions from which the called user must choose when receiving an incoming call;
means for transmitting notification of an incoming call to a communication means accessible to a called user, indicating the alternative actions among which the called user must make a choice, if several alternative actions are identified when executing the rules determined for an incoming call;
means for receiving indications of alternative actions chosen by the called users; and
means for routing incoming calls by implementing the alternative actions chosen by the called users.

19. The call routing server as in claim 18, wherein the call routing server is of modular architecture comprising a central unit and a set of functional modules, and the central unit being designed to coordinate the processing carried out by the functional modules.

20. The call routing server as in claim 18, further comprising:
a configuration module enabling each user to specify a user profile grouping together;
some parameters required by the call routing server including access parameters to the communication means via which the user can be reached, and to present management servers with which the user is registered and which provide an accessibility status to the communication means;
context definitions each corresponding to a situation in which the user has planned to be, each context being associated with respective call routing rules to be applied to incoming calls; and
personal information management data (PIM) specifying the time slots during which a context is activated,

21. The call routing server as in claim 18, wherein to transmit notification of an incoming call to a called user, the call routing server uses at least one of the following communication means:
electronic messaging;
instantaneous messaging;
SMS message;
a display of an overlay window on a computer screen; and
a display of an overlay window on the screen of a television connected to a decoder linked to an IP network.

22. The call routing server as in claim 18, wherein the call routing server is connected to at least one of the following telephony networks:
a mobile telephony network;
a fixed telephony network; and
an IP telephony network using the SIP protocol.

23. The call routing server as in claim 1, wherein the means for carrying out the identified actions on incoming calls and the means for routing incoming calls by implementing the alternative actions chosen by the called user are the same.

24. A user terminal connected to other terminals via an assembly of telecommunication and/or data transmission networks and at least one call routing server, the user terminal being configured to receive a call notification signal from the at least one call routing server and comprising means for displaying the call notification signal, wherein the call notification signal is associated with a list of actions from which the user must make a choice; and the user terminal comprising means for user selection of a choice of action from the list, and means for transmitting the choice made back to the at least one call routing server.
